(19) United States
(12) Patent Application Publication
(10) Pub. No.: US 2006/0058994 A1
(43) Pub. Date: Mar. 16, 2006

(54) Power estimation through power emulation

(75) Inventors: Srivaths Ravi, Plainsboro, NJ (US); Anand Raghunathan, Plainsboro, NJ (US); Joel Coburn, Princeton, NJ (US)

Correspondence Address: NEC Laboratories America, Inc., 4 Independence Way, Princeton, NJ, 08540, US

(73) Assignee: NEC Laboratories America, Inc., Princeton, NJ (US)

(21) Appl. No.: 11/059,839

(22) Filed: Feb. 17, 2005

Related U.S. Application Data
(60) Provisional application No. 60/522,333, filed on Sep. 16, 2004.

(51) Int. Cl. G06F 9/455

(52) U.S. Cl. 703/23

(57) ABSTRACT

The time required to estimate the amount of power that will be consumed by a circuit under design is significantly speeded up. Specifically, the steps involved in power estimation (power model evaluation, aggregation) are implemented as power estimation circuitry that is added to the design of the functional circuit during circuit design. The resulting power-model-enhanced circuit is mapped onto a hardware emulation platform, one of whose outputs is a computation of the estimated power computed by the power estimation circuitry during the emulation. As compared to state-of-the-art commercial power estimation tools, speed-ups from around 10-fold to over 500-fold can be realized.

### CROSS-REFERENCE TO RELATED APPLICATION

This application claims the benefit of U.S. provisional application Ser. No. 60/522,333 filed Sep. 16, 2004.

### BACKGROUND OF THE INVENTION

The present invention relates to techniques for estimating the power consumed by electronic circuits and systems.

Power consumption has emerged as a primary design metric for a wide range of electronic systems. Minimizing and managing power consumption requires appropriate tool support for power consumption estimation (hereinafter “power estimation”) and optimization at various stages in the design methodology, or “design flow.” Extensive research in the low power design area has addressed the problem of power estimation for circuits described at varying levels of abstraction, including the transistor level, logic (or gate) level, register-transfer level, and system level. These technologies have been incorporated into several commercial power estimation tools.

At the transistor level, power estimation is typically performed as a by-product of circuit simulation. Gate-level power estimation requires the computation of signal statistics for the signals in the circuit, which can be performed through simulation, probabilistic analysis, or simulation with statistical sampling. Of these, simulation with a comprehensive test bench is the most commonly used in practice, due to its accuracy and the ability to produce detailed feedback such as power breakdown versus time for different circuit components. At the register-transfer level, approaches to power estimation include analytical techniques, characterization-based macromodels, or fast synthesis into gate-level descriptions. While a few attempts have been made to perform power estimation at the behavioral level, accuracy is limited due to the lack of structural circuit information in behavioral descriptions. At the system level, most research has focused on developing power models for different system components, including processors, memories, on-chip buses and others.

In practice, most current commercial design flows utilize register-transfer-level and gate-level power estimation tools. However, due to their poor efficiency for large designs, the applicability of those tools is limited until late in the design flow, or they are applied only to small parts of a design.

Advances in fabrication technologies have led to shrinking device sizes and consequently to increasing chip complexities. This increase in complexity is straining the capabilities of conventional power estimation tools. For example, in an experiment conducted by the applicants, register-transfer-level power estimation for a 1.25 million transistor MPEG4 decoder circuit when decoding just 4 frames of a video stream required 43 minutes for one state-of-the-art commercial power estimation tool and 55 minutes for another. Gate- and transistor-level power estimation tools can be as much as 100 times slower. The slow speed of power estimation tools limits their utility in the design flow and certainly renders them impractical for use in an iterative manner for architectural exploration. Hence, efficient power estimation for large designs is a critical challenge.

Speed-up techniques such as statistical sampling and circuit partitioning for parallel mixed-level simulation offer useful improvements in efficiency but are not sufficient in the face of ever-increasing circuit complexities. Raising the level of abstraction to the system level can lead to substantial efficiency improvements, but accuracy is then significantly compromised.

### SUMMARY OF THE INVENTION

Power estimation is typically performed by evaluating software-implemented power estimation models (hereinafter “power models”) for different circuit components, based on the input and output values of each component during circuit simulation. The present invention is informed by our prior realization that those power models can themselves be thought of as synthesizable functions and implemented as circuitry—referred to herein as “power estimation circuitry.” See our paper with S. Chakradhar, “Efficient RTL power estimation for large designs,” in Proc. Int. Conf. VLSI Design, January 2003. That paper, as well as all of the prior art cited herein is hereby incorporated by reference as though fully set forth herein.

We refer to our inventive technique as “power emulation.” Power estimation circuitry is added to the circuit description of the design of the circuit whose power is desired to be estimated, referred to herein as the “functional circuit.” The functional-circuit-plus-power-estimation-circuitry—referred to herein as a “power-model-enhanced circuit”—is then emulated by producing, in response to the circuit description, a circuit-implemented emulation that emulates the power-model-enhanced circuit in just the same way that the functional circuit could or would be emulated. Illustratively, the power-model-enhanced circuit is realized on an emulation platform by configuring a configurable circuit system in response to the circuit description. In the disclosed embodiment, in particular, the power-model-enhanced circuit is realized by programming one or more FPGAs (field-programmable gate arrays) of the emulation platform. Among the outputs of the emulated power-model-enhanced circuit, once executed on the emulation platform, is the estimated power that was computed by the power estimation circuitry.

The power estimation circuitry is not intended be included in the final design of the functional circuit. Rather, it is intended that the power estimation circuitry be included in the circuit design only initially, in order to evaluate the power consumption characteristics of the functional circuit. Once the final design of the functional circuit has been decided upon, the functional circuit would be manufactured without the power estimation circuitry. (The power estimation circuitry could, however, be included in the final design if there was some specialized need or desire for it.)

Advantageously, we have found that the present invention can facilitate a speed-up in power estimation, as compared to existing power estimation tools, by factors of 10 to over 500, depending on the application, with little or no loss of accuracy in the estimation. Thus, much like functional emulation, the power emulation technique of the present invention can enable the investigation of circuit characteristics in the context of realistic system environments and workloads, such as booting up an operating system. Using prior art power estimation tools, this is a task that can often be achieved as a practical matter only after circuit fabrication.

When added to the functional circuit, the power estimation circuitry could, in many cases, cause the power-model-enhanced circuit to be too large to be handled by whatever emulation platform may be available to the user. In one case, for example, we added power estimation circuitry to the register-transfer-level design of an MPEG4 decoder circuit. It was computed that the invention would decrease the time required for power estimation by a factor of about 400 as compared to a commercially available power estimation tool. However, straightforward realization of the power estimation circuitry using an FPGA-based emulation platform would have increased the overall area (number of primitive FPGA elements required to implement the circuit) by a factor of as much as 18.2, greatly outstripping the capacity of the emulation platform that was available.

In accordance with a feature of the invention, embodiments of the invention keep the size of the power-model-enhanced circuit to workable levels by employing one or more of a suite of techniques that reduce the size of the power estimation circuitry. These include power model reuse across different circuit components, regulating the granularity of components for power modeling, exploiting inter-component power correlations, resource sharing for power model computations, and the use of block memories for efficient storage within power models.

In particular experiments in which one or more of the aforementioned techniques were used to design the power estimation circuitry, the power-model-enhanced circuit was, on average, 3.1 times the area of the functional circuit, which was well within the capabilities of the considered emulation platform. The amount of time required by that particular design for power estimation was on the order of only 1/200^{th}, or 0.5%, of the time required for each of two commercially available power estimation tools. And the cost of power emulation in terms of estimation accuracy averaged a modest 3.4% loss of accuracy.

The invention is applicable at any level of abstraction of the functional circuit, e.g., transistor level, logic (or gate) level, register-transfer level, or system level. Indeed, we believe that the invention can significantly extend the scope of current register-transfer-level, gate-level or other level power estimation techniques, making them applicable to large designs with little or no tradeoff in accuracy. The advantages of the invention as compared to commercially available power estimation tools are particularly manifest when the functional circuit is particularly large and complex.

### BRIEF DESCRIPTION OF THE DRAWING

FIG. 1 is a block diagram of a functional circuit to which has been added power estimation circuitry pursuant to the principles of the present invention;

FIG. 2 is a block diagram (or “netlist”) of a typical power model of the power estimation circuitry of FIG. 1;

FIG. 3 is a flow diagram depicting an illustrative design flow incorporating the principles of the present invention;

FIG. 4 is a flow diagram depicting illustrative details of one of the steps of the design flow depicted in FIG. 3;

FIG. 5 is a generic power model that can be used as the power model for a cluster of components of the functional circuit of FIG. 1; and

FIGS. 6-11 are charts and graphs helpful in explaining various aspects of the illustrative implementation of the invention.

### DETAILED DESCRIPTION OF AN ILLUSTRATIVE EMBODIMENT

1.0 Overview

The concept of power emulation pursuant to the principles of the present invention is applicable at different levels of abstraction. It is here presented in the context of register-transfer level (RTL) power estimation. Since RTL descriptions in practice can contain an arbitrary combination of macroblocks (arithmetic units, registers, multiplexers, etc.) and random logic gates, the descriptions herein apply directly to gate-level descriptions as a special case.

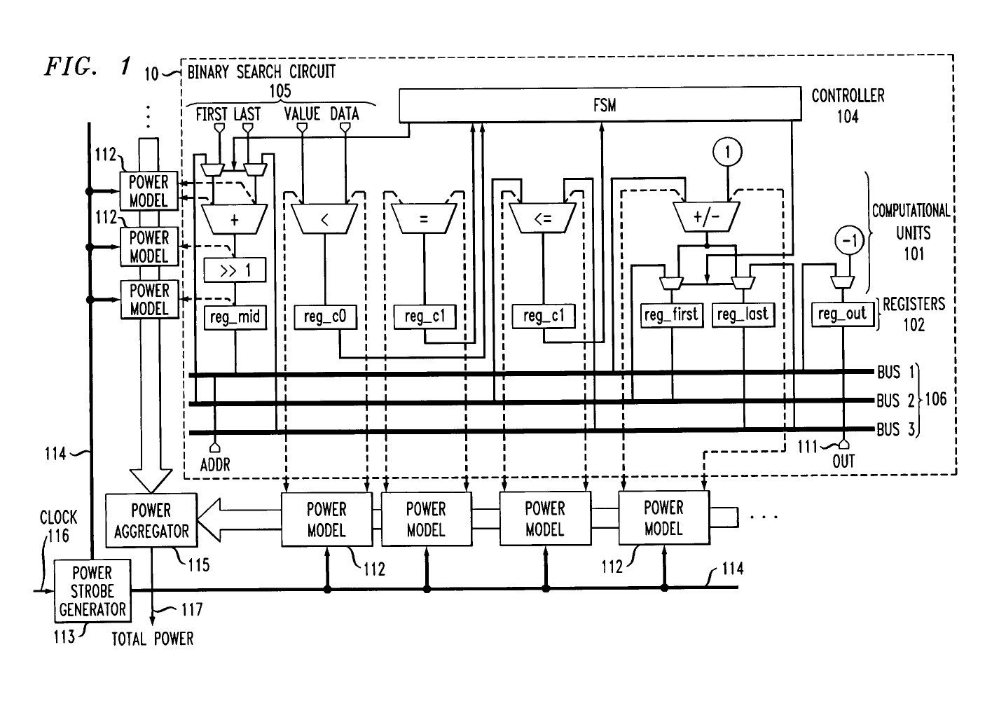

The power-model-enhanced circuit of FIG. 1 includes a functional circuit 10, which is illustratively a binary search circuit of conventional design, represented at the register-transfer level. The binary search circuit 10 includes a number of computational units 101, registers 102 and buses 106, operating under the control of a controller 104. Inputs 105 for the binary search circuit are the conventional “first,” “last,” “value,” and “data” inputs. The output of the binary search circuit, indicated at 111, is labeled “out”.

In accordance with the principles of the invention, functional circuit 10 is interconnected with power estimation circuitry comprising power models 112, power strobe generator 113 and power aggregator 115. The power estimation circuitry is adapted to generate at least one estimate—illustratively a succession of estimates—of the power consumption of at least a portion of the functional circuit, the estimate(s) being generated as a function of input signals applied to the power-model-enhanced circuit once it has been realized as a circuit-implemented emulation (as described below) and the emulation is thereafter executed.

In particular, each RTL component (the various computational units, registers, the controller, etc.) of the binary search circuit 10 has an associated power model. For clarity, not all of the power models are explicitly shown. Moreover, although not shown in this particular FIG., a single power model can be used to service all components in a cluster of the RTL components. This is described in further detail hereinbelow. Each power model computes the current power consumption of the associated functional circuit component whenever the power model is triggered, or strobed, by power strobe generator 113.

Computing the power consumption of a component requires a power model to take account of both the input and output signals of the component. It is possible, however, to not actually connect a component's outputs to the associated power model. Rather, the power model can be designed in such a way—based on a knowledge of the function that the associated component performs—as to take account of what the output of the component will be for a given set of inputs and to thus compute the power consumed by that component. This approach will make the power model more complicated than it would otherwise be, but may be desirable because it reduces the number of leads connecting the functional circuit to the power estimation circuitry and thus achieves circuit simplification at the functional circuit/power estimation circuitry interface.

Power strobe generator 113 provides triggers to each of the power models 112 via strobe leads 114, causing the power models to evaluate the power consumption of the associated circuit components at that particular time. When strobed by power strobe generator 113, each power model outputs a signal to power aggregator 115 indicating the evaluated power consumption of the associated component at that particular time. Power aggregator 115 implements a sequence of additions to accumulate the total power from the outputs of the power models and thus the total power consumption of the RTL components. The total power is output on lead 117.

Power strobe generation is similar to clock generation and is done separately for each clock domain in the design. For example, power strobe generator 113 can receive each of the different clock signals that may be used in the functional circuit and can strobe those power models whose associated components' states are expected to be affected by any given clocking. FIG. 1 shows a single such clock signal being provided on clock lead 116.

Each power model is a circuit implementation of a power macromodel constructed using known techniques. Each macromodel is illustratively a cycle-accurate linear-regression-based macromodel that expresses the power consumed in an RTL component with n input/output bits as

$${\sum }_{i = 1}^{n} {Coeff}_{i} * T ( {x}_{i} ) ,$$

where Coeffᵢ represent the power model coefficients, and T(xᵢ) is the transition count (0 or 1) at each input/output bit. Further description of such macromodels can be found, for example, in L. Benini et al, “Regression models for behavioral power estimation,” Proc. Int. Wkshp. Power & Timing Modeling, Optimization, and Simulation (PATMOS), 1996 and in Q. Wu et al, “Cycle-accurate macro-models for RT-level power analysis,” IEEE Trans. VLSI Systems, vol. 6, pp. 520-528, December 1998.

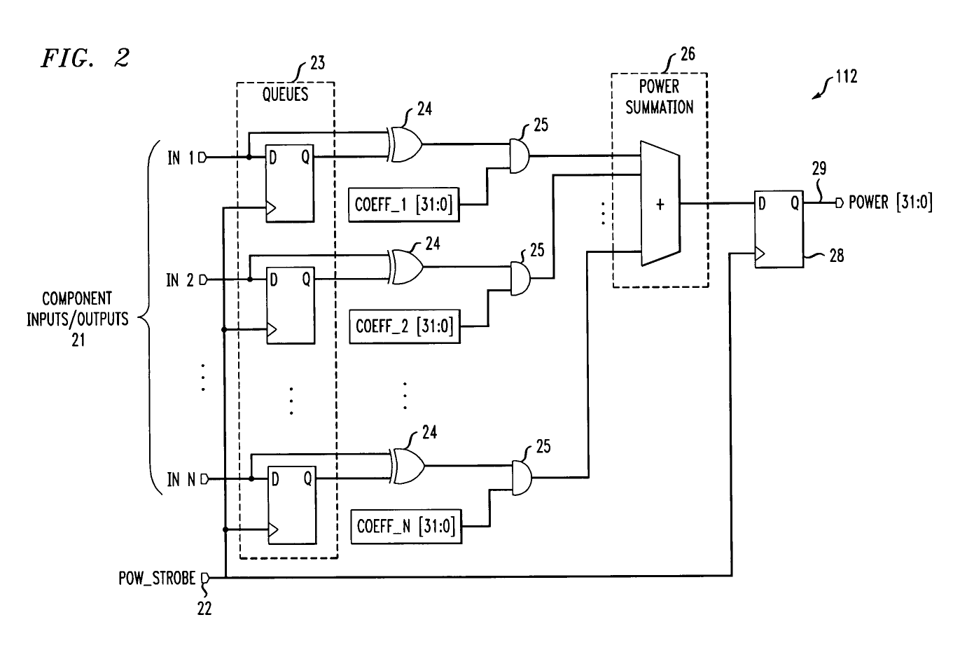

FIG. 2 shows a circuit implementation of such a power model 112 used for the purpose of power emulation pursuant to the principles of the invention. The inputs to the power model include the input/output bits 21 of the associated component being monitored and a power strobe (POW_STROBE) 22 from power strobe generator 113. The output of the power model is an estimate of the associated component's power consumption at the time of the strobe. That estimate is a function of at least a) the input bits and b) coefficients that characterize the power consumption characteristic of the circuitry whose power is being estimated.

In particular, the power model illustratively performs the computation

$$\begin{matrix}Power = tc ( {queue\_x}_{1} ( 0 ) , {queue\_x}_{1} ( 1 ) ) * {Coeff}_{1} + … + \\ tc ( {queue\_x}_{N} ( 0 ) , {queue\_x}_{N} ( 1 ) ) * {Coeff}_{N}\end{matrix}$$

where, tc represents the transition count (EXCLUSIVE-OR) function carried out by exclusive-or gates 24. The inputs to tc come from a set of internal queues 23 that maintain the previous and current values of each component input/output. Since the transition count is a binary value, the multiplications in the power model equation are implemented simply using vector AND gates 25. The products of the coefficients and respective transition counts are added by power summation 26 to obtain the power consumed by the component in the current strobe period. The output of power summation 26 is strobed into output register 28, which is output on lead 29 to power aggregator 115.

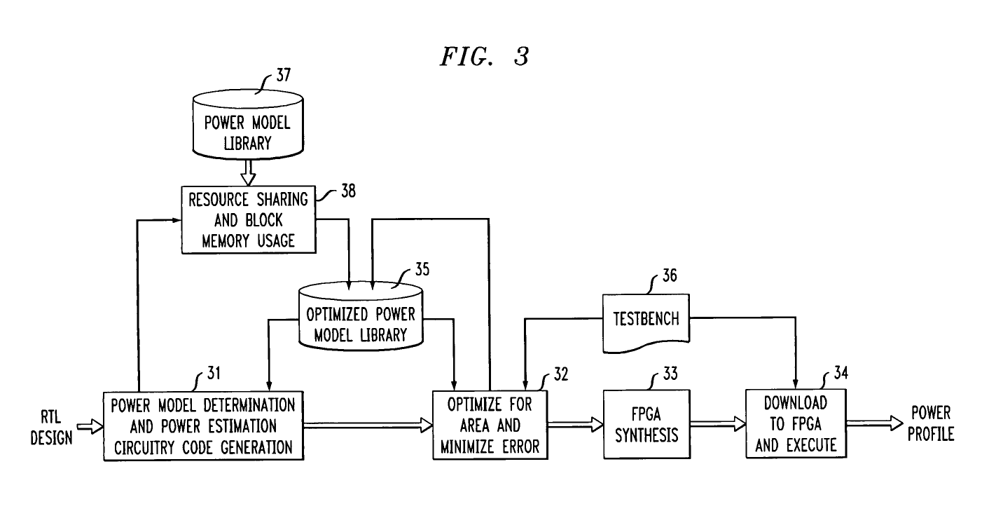

FIG. 3 is a flow diagram depicting an illustrative design flow incorporating the principles of the present invention.

Step 31 receives the functional circuit RTL design described in a circuit-description language such as Verilog, VHDL, or SystemC. This step determines what power models are required for every component in the design. Pre-constructed power models are stored in power model library 37. The pre-constructed power models are described using the same circuit-description language in which the components of the functional circuit are described. Reference may be had in this regard to our above-cited January 2003 paper. The required power models determined by step 31 are identified to step 38, which obtains code from library 37 implementing those models. Step 38 derives optimized versions of the models using the techniques of resource sharing and block memory usage as described below, and it stores the derived optimized power models in optimized power model library 35. Step 31 inserts into the RTL design from optimized power model library 35 the code describing the required power models, as well as the other required power estimation circuitry.

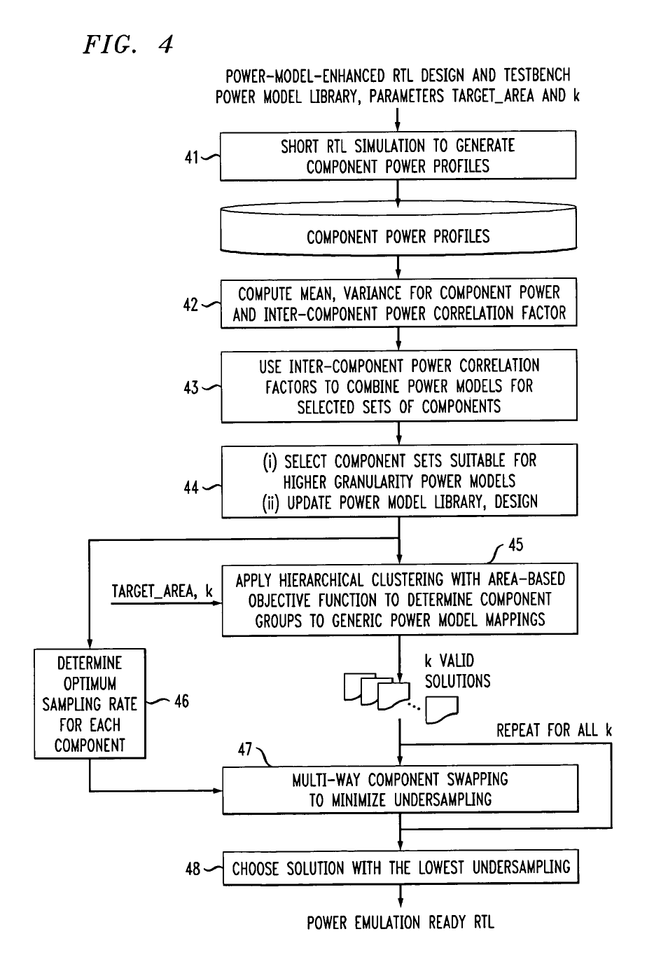

Step 32 comprises a number of substeps that are shown in FIG. 4 and are described below. In overview, step 32 optimizes the description of the power model enhanced RTL design so that it can meet a target area budget (based on the capacity of the emulation platform), while minimizing any loss in estimation accuracy. The output of step 32 is an RTL description that is used to configure a general purpose circuit to emulate the power-model-enhanced circuit. In particular, the RTL description is fed for this purpose to FPGA synthesis tool flow at step 33. The resulting logic level description, or netlist, is downloaded to an FPGA-based emulation platform at step 34 for programming of the FPGA—interconnecting its array of gates—to become a circuit-implemented emulation of the power-model-enhanced circuit. The FPGA is then executed by test bench 36, which applies a set of signals to the portion of the emulation that emulates functional circuit 10. The portion of the emulation that emulates the power estimation circuitry thereupon provides indications of the power estimates that it generates. Those estimates, taken over time constitute a power profile for the functional circuit. The power profile, more particularly, may be, for example, a measure of the functional circuit's average power consumption, its peak power consumption, or a cycle-by-cycle power consumption profile of the entire circuit or any part thereof, as suits the circuit designer's needs. It can also be used to separate the static part of a circuit's power consumption (e.g., leakage) from the dynamic part.

Illustrative details of step 32 are shown in FIG. 4. The methodology takes as its input a) the power model enhanced RTL circuit design and its test bench, b) optimized power model library 35, and c) parameters including a target area constraint (target_area) imposed by the emulation platform and a selected clustering algorithm control factor k as described below. The output of step 32 is a power-emulation-ready-RTL description, i.e., a description of the power-model-enhanced circuit, that can meet the constraint target_area with a minimum loss of estimation accuracy.

The following is an overview of the various steps shown in FIG. 4. Further details as to how various of those steps are illustratively implemented are presented thereafter.

Step 41 involves running an RTL simulation using conventional simulation software for a short, user-selected interval to generate the power profiles for all the components—that is, their power consumption characteristics over time, given a set of inputs from the test bench. This is done because the power profiles are then used at step 42 to generate various indicators of the components' power consumption characteristics, these being, in this embodiment, (i) mean and (ii) variance of the component power profiles, and (iii) inter-component power correlation factors. These statistics are used by the area reduction techniques carried out at steps 43-45.

Step 43 identifies components whose power consumption statistics are strongly and linearly correlated, based on whether an inter-component power correlation factor (described below) exceeds a fixed or, alternatively, a user-specified threshold. The power models for components whose power consumption statistics are strongly and linearly correlated are combined into a new power model, which can estimate the power consumption for all the components by monitoring the inputs of any one of the correlated components. This reduces the number of components with unique power models.

Step 44 identifies sets of components for which construction of higher granularity power models is suitable. To the extent that that is the case, optimized power model library 35 is updated accordingly, as shown in FIG. 3 by an arrow from step 32 to library 35. This is desirable since the higher granularity power models can be used for other (subsequent) designs for which one may wish to perform power emulation. Moreover, the process of constructing higher granularity power models is similar to the process of constructing the original power models themselves, making such updating a logical way of constructing the higher granularity power models. Since the number of such sets is exponential, one can use empirical studies to consider only connected components (higher potential of area savings) and small sets with up to three components (likely to have lower loss of estimation accuracy). Finally, if the fitting error for the resultant power model is higher than is adjudged to be desirable, then the new power model is not a good choice and should be dropped.

The task now is to reduce the number of power models further by determining component clusters that can be mapped to generic power models. Steps 45-48 provide a two-phase strategy in order to meet the target area constraint with a minimum loss of accuracy. In the first phase, at step 45, a hierarchical clustering algorithm is used to determine from among the possible clustering solutions that meet the target area constraint some number k of those solutions. Larger values of k provide greater flexibility in meeting power estimation circuitry design objectives, at a cost of additional time consumed by the design flow. In the second phase, at step 46, we first compute a measure of the relative significance of each component to the overall power profile, based on the component power mean and variance. This allows us to compute a desirable sampling rate for each component (i.e., how often its inputs are sampled by the associated power model) for any given power model latency (i.e., the number of clock cycles that the power model uses to carry out a power computation after having done the sampling).

The area-optimized solutions of step 45 can result in undersampling (an actual sampling rate that is less than the desirable sampling rate) for some components and oversampling (an actual sampling rate that is greater than the desirable sampling rate) for others. Undersampling can result in higher estimation errors. Hence, Steps 47 and 48 attempt to minimize component undersampling. For each of the k solutions identified in step 45, a classical multi-way component swapping between clusters is performed at step 47 to minimize the undersampling. Two components that belong to different clusters are chosen, and the impact of swapping them (moving each into the other's original cluster) on undersampling is computed. A sequence of such swaps is constructed that results in a cumulative reduction in undersampling. In order to explore many solutions, swaps that locally increase the undersampling may be accepted (in the hope that they lead to a sequence with a better cumulative reduction). The k initial solutions produced by step 45 are thus convereted into k further optimized solutions. Step 48 then examines the clustering solutions produced by step 47, and chooses the solution with the lowest undersampling to generate the power model enhanced RTL circuit description ready for power emulation.

Further specifics of steps 42-47 are detailed in the following sections.

2.0 Reduction of Area Requirements—Steps 42-45

This section presents a suite of techniques that reduce the area requirements of the power-model-enhanced circuit. These techniques are based on the observation that power models dominate the overall circuit area, since they are instantiated for every component in the design. The suite of techniques attempts to reduce the number of power models in a design. They also help make area-efficient implementations of the power model logic, without a significant loss of power estimation accuracy. In a given application, any number of these techniques, including none of them, may be used depending, for example, on the extent to which it is desired or necessary to reduce the size of the power estimation circuitry, and thus of the overall power-model-enhanced circuit, in order to meet constraints imposed by the emulation platform—notably the available FPGA area.

2.1 Power Model Re-Use Through Clustering—Step 45

The number of power models required for a design can be reduced by grouping components into clusters and by using a single power model to service all components in a cluster on a time-shared basis. In effect, a component may be considered by the power model (or “sampled”) only once in several cycles, similar to statistical sampling. See, for example, R. Burch et al, “A Monte Carlo approach for power estimation,” IEEE Trans. VLSI Systems, Vol. 1, pp. 63-71, March 1993.

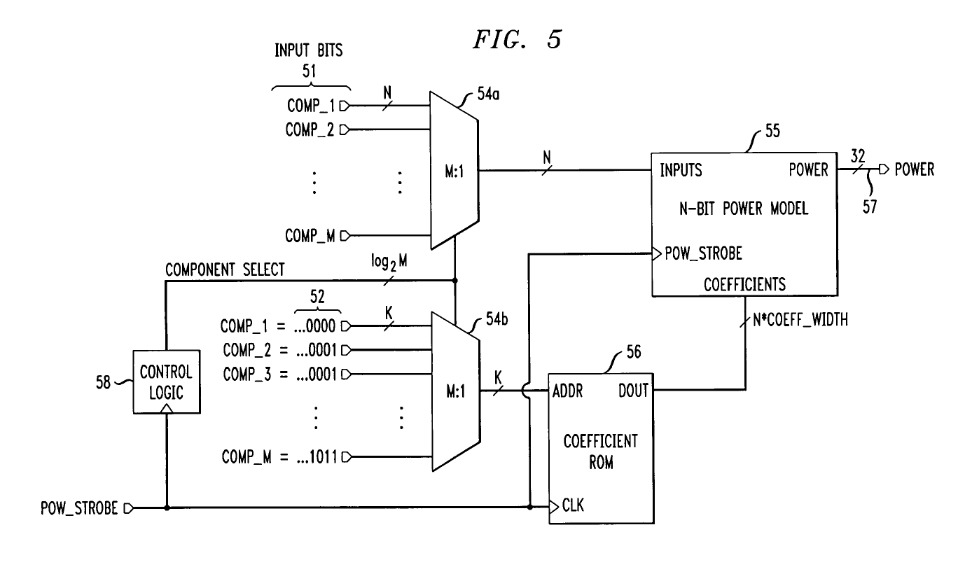

The architecture of a generic power model that services a cluster of M components is shown in FIG. 5. It consists of (i) input multiplexers 54a and 54b that select the component inputs 51 to be monitored at a particular time and the corresponding macromodel coefficients, (ii) a ROM 56 containing the arrays of coefficients for each type of component in the cluster, and (iii) a basic N-bit power model 55, such as of the type shown in FIG. 2, for calculating the component power consumption value, where N is the maximum number of input bits that are monitored among all components in a cluster, this being referred to as the maximum bit width. (In this embodiment the outputs of the various components are not measured directly but are taken into account in the design of the power models, as was suggested earlier.) The area of the generic power model is chiefly governed by trade-offs between the number of components being serviced (which determines the multiplexer size) and the largest bit width component (which determines the size of the adder tree within the power model).

Control logic 58, responsive to an overall clock signal of the power-model-enhanced circuit, controls the selection of which component's inputs are the ones to be sampled at any given time by the power model. To this end, control logic 58 generates a log₂M-bit-wide selection signal that is applied to multiplexers 54a and 54b, thereby identifying the selected component. The algorithm by which control logic 58 generates the selection signal is determined based on how often the various components are to be sampled, per the considerations described above.

In operation, control logic 58 identifies a particular component to multiplexers 54a and 54b. Multiplexer 54a responds by providing the (up to) N input bits of that component to “Inputs” of power model 55. At the same time, multiplexer 54b selects as an address for ROM 56 the address on one of its M K-bit-wide inputs associated with the selected component. The selected address is provided to ROM 56, causing the latter to provide N coefficients at “dout” and provide them to power model 55. Power model 55 is thus provided with the inputs necessary for power consumption computation, as described above in connection with FIG. 2, and it provides the computed power on lead 57 to power aggregator 115.

Clustering reduces area because it shares power model resources, but there are a few caveats with the generic power model that affect its efficiency. The maximum number of monitored points from the serviced components determines the power model bit width. For some components in the cluster, this requirement means that the input bits and matching coefficient array are padded with zeros. Coefficient ROM 56 must have a data bit width of N*coeff_width to meet the bandwidth requirement of the power model. At the cost of estimation accuracy, we can relax this requirement and allow multiple cycles for the power model's power computation. ROM 56 is illustratively implemented as a clocked device to support this multi-cycle feature. The size of ROM 56 is dictated by the heterogeneity of the components in a cluster. When there are multiple instances of the same type of component, only a single copy of the coefficients is stored in the ROM.

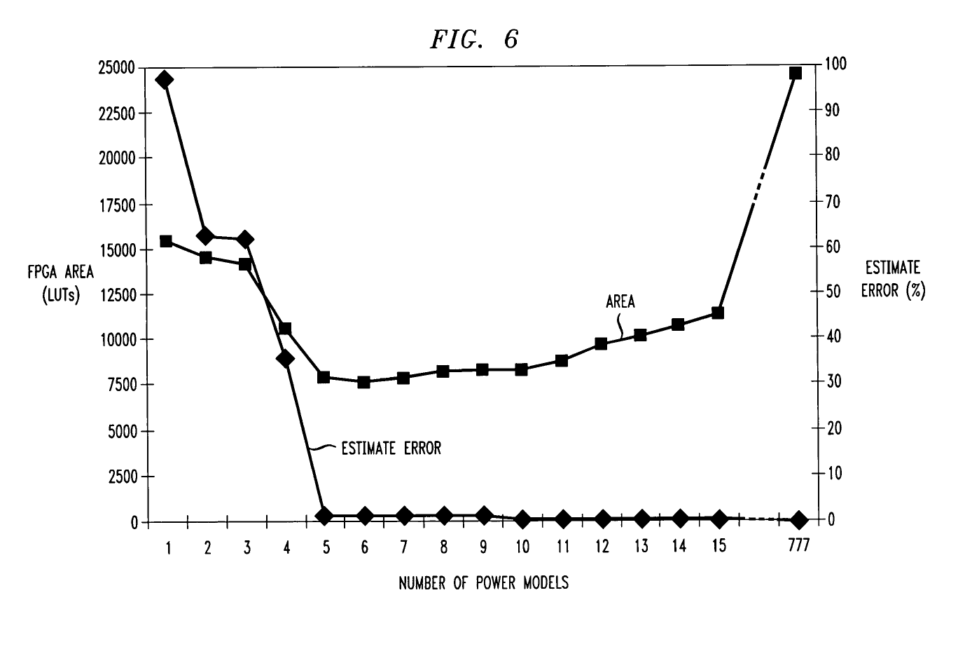

FIG. 6 shows the impact of clustering on area reduction and estimation error for a bubble sort circuit that we investigated. The design contained 777 RTL components, and we considered various clustering solutions by varying the number of generic power models allowed. At one extreme, there are 777 power models (with one power model per component) and this configuration results in the highest area cost of about 25,000 LUTs with zero estimation error. (A LUT is a standard area measurement unit in this technology.) When the number of generic power models reduces to six, the area curve is at a minimum value that is 3 times smaller, namely 7,615 LUTs. At the same time the estimation error has risen to about 1%.

As the number of power models is decreased further, we first note that the estimation error increases sharply. This is to be expected, since the estimation error depends on the frequency with which a component is sampled for power consumption, and sampling frequency decreases as the number of components serviced by a model increases. Secondly, we observe that area requirements start increasing again. The parabolic nature of the area curve in FIG. 6 is explained by tradeoffs between multiplexer and adder area costs. Decreasing the number of power models means that each model services more components, thus requiring larger multiplexers, a situation that begins to outweigh the benefits of having fewer adders. Thus, we must carefully consider the conflicting trends imposed by the multiplexer and adder costs of a generic power model while performing clustering.

The clustering is illlustratively carried out using a hierarchical clustering algorithm such as that disclosed in A. K. Jain et al, Algorithms for Clustering Data, Prentice Hall, Englewood Cliffs, N.J., 1988. This algorithm takes as its input the list of components, and outputs several candidate clustering solutions that meet the specified target area constraint. With an initial state wherein every component forms a distinct cluster and each cluster is associated with a power model, the algorithm proceeds as follows:
1. Evaluate pairwise the cost of combining two clusters into a single cluster. The cost is given by the size in LUTs of a generic power model that will be used to service all the components in the two clusters. In other words, if CLᵢ and CLⱼ are two clusters, the area cost of a generic power model that services the cluster CLᵢ+CLⱼ is approximately given by

$$\begin{matrix}Area ( {CL}_{i} + {CL}_{j} ) \approx ( max ( {BW}_{{CL}_{i}} , {BW}_{{CL}_{j}} ) - 1 ) * {Area}_{add} + \\ max ( {BW}_{{CL}_{i}} , {BW}_{{CL}_{j}} ) * {Area}_{mux} ( \vert {CL}_{i} \vert + \vert {CL}_{j} \vert )\end{matrix}$$
where, the first term denotes the contribution due to the power model computation and the second term denotes the contribution due to the input multiplexer. BW_{CL}_{ᵢ} denotes the bit width of the largest component in cluster CLᵢ (with cardinality CLᵢ), Area_{add} denotes the size of a basic adder required to add the products of the power model coefficients and transition counts, and the function Areaₘᵤₓ(n) returns the area corresponding to a n-to-1 multiplexer.
2. Choose the pair of clusters that can be combined to result in the best area savings (Area (CLᵢ)+Area (CLᵢ)−Area(CLᵢ,CLⱼ)) and update the bit width of the resultant cluster as max(BW_{CL}_{ᵢ},BW_{CL})
3. Repeat the above steps until k solutions that meet the target area constraint are found or all components are in a single cluster.
   2.2 Exploiting Inter-Component Power Correlations—Steps 42-43

The power consumptions of several components in a design are often correlated due to the functional circuit topology. Correlations can be exploited to reduce the number of components being explicitly monitored, since the power consumption of correlated components can be potentially inferred by monitoring one component in that set. For example, if Pₓ and P_{y} are power consumption variables correlated by a function ƒ such that P_{y}=ƒ(Pₓ), then we can monitor only component x to obtain Pₓ, and apply ƒ to compute P_{y}, as long as a selected correlation criterion is met.

In particular, for power emulation, since the correlation function will also be implemented as circuitry, it is desirable for function ƒ to be simple, requiring very few circuit resources. A linear fitting function, for example, meets these requirements. Additionally, the linear correlation must be strong. The correlation between two components can be expressed by the statistical correlation coefficient (p) between two power consumption variables Pₓ and P_{y} as follows.

$$ρ = \frac{E [ ( {P}_{x} - {μ}_{x} ) ( {P}_{y} - {μ}_{y} ) ]}{{σ}_{x} {σ}_{y}} = \frac{Cov ( {P}_{x} , {P}_{y} )}{{σ}_{x} {σ}_{y}}$$

where μₓ, μ_{y} are the means and σₓ, σ_{y} are the standard deviations of Pₓ, P_{y} See, for example, G. G. Roussas, A Course in Mathematical Statistics, Second Edition, Academic Press, London, UK, 1997. The value of ρ can vary from −1 to 1, where a large value of ρ (positive or negative) indicates strong linear correlation.

Given a reference component, a threshold value for ρ may be chosen such that any components with a correlation coefficient of at least that amount—that is, components having corresponding power consumption variables that are linearly correlated to at least a predetermined extent—can be grouped together and replaced by a linearly scaled version of the reference component.

The following two examples are provided to show (i) varying degrees of linear correlation between component power and (ii) how components with similar values of ρ can be collapsed into a single power model.

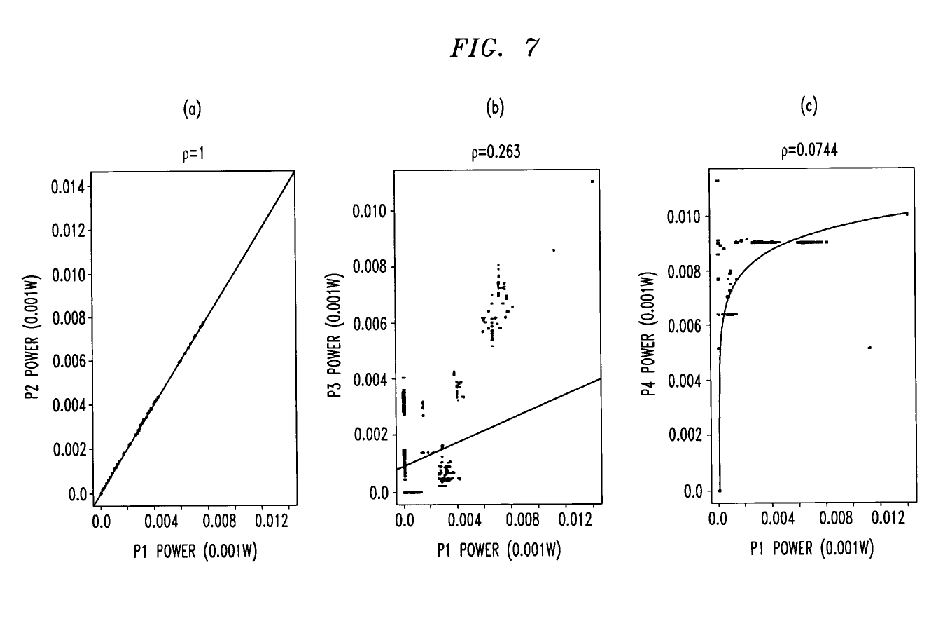

FIG. 7 plots the correlation between the power profiles of various component pairs in the aforementioned bubble sort circuit design. Using a 12-to-1 multiplexer as the reference component (power consumption P₁), we examine its correlation with two other 12-to-1 multiplexers (power consumptions P₂ and P₃), and a register that forms an input to our reference component (power consumptions P₄). FIG. 7(a) shows that P₁ and P₂ are perfectly correlated with ρ=1 (it turns out that they are a duplication of the same component implemented in the functional circuit in order to improve the circuit's timing characteristics). FIG. 7(b) shows that components P₁ and P₃ are weakly correlated with p=0.263, while FIG. 7(c) shows that P₁ and P₄ are strongly correlated non-linearly, but weakly correlated linearly. Thus, in this example, we monitor P₁, P₃ and P₄, and use P₁ to infer P₂.

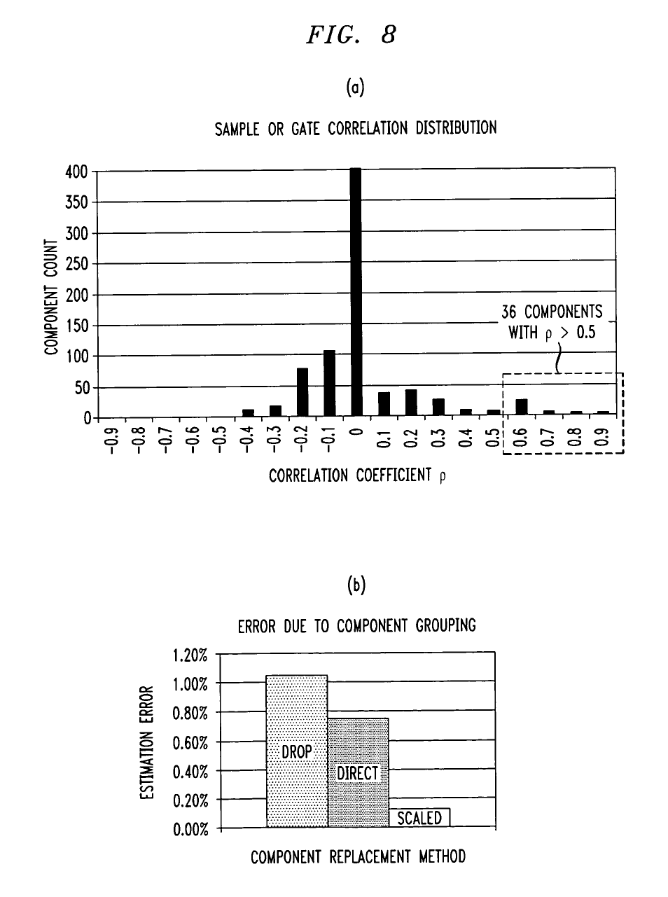

FIG. 8 illustrates how power correlations can be exploited to optimize the power estimation circuitry for the bubble sort circuit design. The histogram of FIG. 8(a) shows the distribution of correlation coefficients for all components in the design, relative to one specific OR gate. There are 36 components that have a correlation coefficient ρ>0.5 (we assume 0.5 to be the correlation threshold in this example). Therefore, there are 36 components in the bubble sort circuit design whose power consumption can be computed by a power model that monitors only the single OR gate. The computed power is then scaled up to reflect the power consumption of the 36 components. The scaling can be implemented in any of a number of equivalent ways, including (i) as part of the power model itself, (i) as a separate unit that is cascaded to the output of the appropriate power model, or (iii) as part of the power aggregation circuitry. FIG. 8(b) shows the estimation error that results from different approaches to estimating the power consumption of the 36 components identified in FIG. 8(a). The 36 components are responsible for 1.04% of the total power consumption. Ignoring the power consumed by these components when computing the total circuit's power consumption will therefore result in an error of 1.04% (see the bar marked “DROP” in FIG. 8(b). By naively substituting the OR gate power for the power of any component in the group, the estimation error improves to 0.75% (see the bar marked “DIRECT” in FIG. 8(b)). However, based on further analysis, we observed that it was possible to scale the power consumption of the OR gate by a factor of 4 to approximately include the power consumption of the other 36 components. This approach (marked “SCALED” in FIG. 8(b)) results in an estimation error of only 0.13%. To save area, the scaling factor is chosen as a power of 2 so that it can be implemented in circuitry as a bit shift operation.

2.3 Changing Component Granularity—Step 44

A power model enhanced RTL circuit description contains power models for every component in an RTL design. We can modify this policy by increasing the granularity of the components for which power models are (pre-)constructed and instantiated. In other words, we can construct a new entity comprising several RTL components, characterize this entity and use the resultant power model. Thus, by increasing the component granularity, we lower the number of power models, leading to a decrease in area. However, as shown by the following example, increasing component granularity has a significant impact on estimation accuracy.

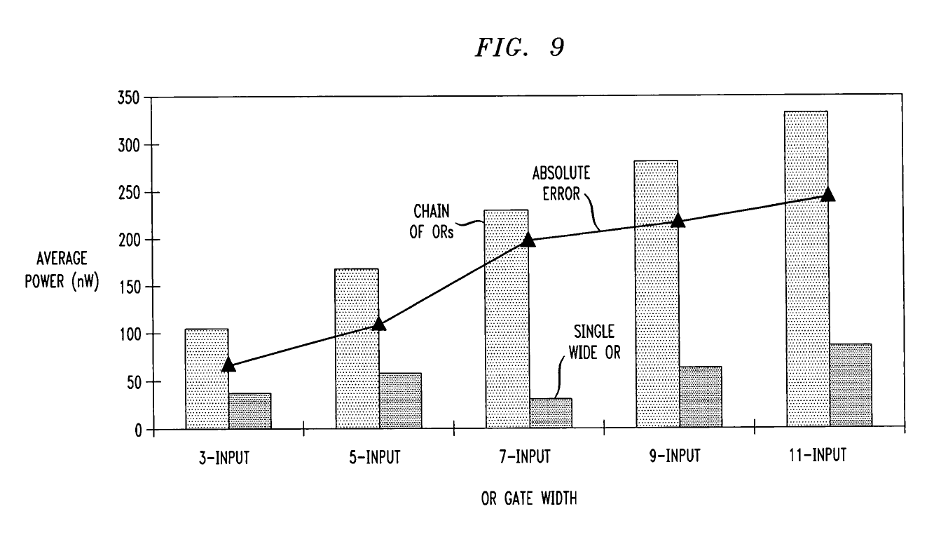

We consider a design that implements the popular DES encryption algorithm and contains several chains of two-input OR gates. In the power model enhanced RTL circuit description, a power model is dedicated to each OR gate, but we can combine several consecutive gates in a chain to form a wide-OR entity and construct the corresponding power model. FIG. 9 plots the impact on estimation accuracy as the size of the coalesced gate increases (from 3 inputs to 11 inputs). The plot shows that the absolute error increases monotonically. This trend can be explained by the fact that when several 2-input gates are coalesced and subsumed by a large power model, the internal signals are no longer explicitly modeled and are subject to the effectiveness of the new power macromodel. This implies that it is often only practical to group small numbers of components into a single entity.

3.0 Resource Sharing For Power Model Computation—Step 38

Classical resource sharing techniques can be employed to make the computation in the power model area-efficient. In particular, the power consumption computation performed by a power model can be carried out over multiple power-model-enhanced circuit clock cycles, thereby allowing adder circuitry within the power model to be used multiple times successively in the course of the computation. A power model with N bits of input typically requires a chain of N−1 adders to compute the power. The area requirements can be reduced using a statically scheduled tree configuration.

An adder tree with a width of A adders computes a sum in log₂(A) cycles, assuming all terms can be read in one cycle. However, the bandwidth limitations of circuitry restrict the number of macromodel coefficients that can be read in a cycle. A scheduler reads one new input value for each adder per cycle, reducing the required bandwidth and simplifying control logic. Assuming a one-cycle latency for coefficient storage, the sampling period Tₛₐₘₚₗₑ for a power model with bit width N and A adders is given by

$${T}_{sample} = ⌈ \frac{N}{A} ⌉ + {log}_{2} ( A ) + 1$$

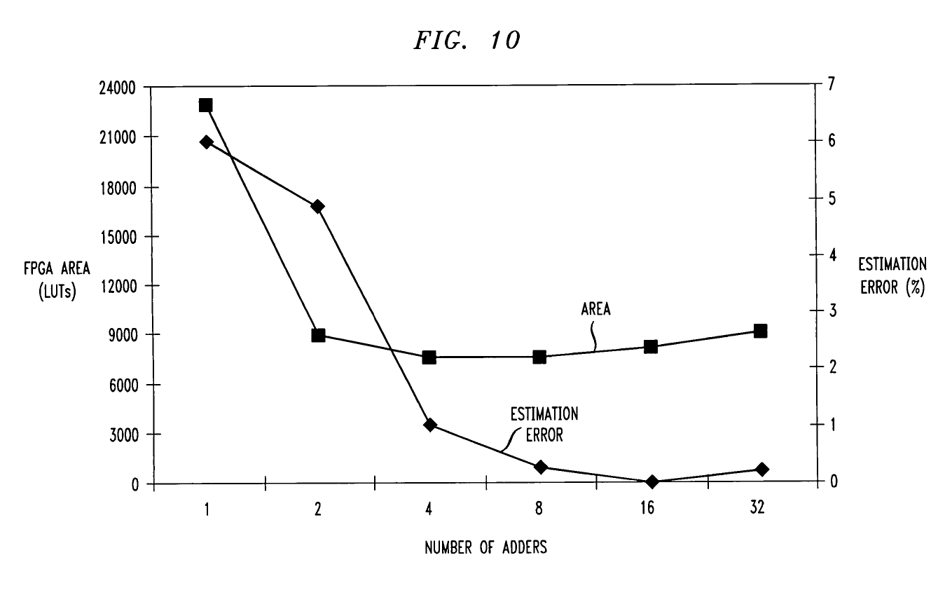

Since resource sharing increases the inter-component sampling period, estimation error also increases. For example, FIG. 10 plots the area and estimation error for the bubble sorting circuit design as a function of the number of adders allowed per power model. With 8 adders, we obtain the minimum area (7504 LUTs) and the estimation error is almost negligible (0.26%). As expected, estimation error declines as we increase the number of adders per power model. At the same time, area exhibits an interesting trend by descending rapidly, reaching a minimum, and then rising slowly. Scheduling overhead dominates power model area for a small number of adders, where large multiplexers are placed at the input of each adder to select the correct coefficient during each cycle of computation. An increasing number of adders lessens (and often eliminates) the scheduling overhead. Also, adders are area-efficient because FPGA architectures are typically optimized with dedicated carry-chain logic. Thus, for a growing number of adders beyond the optimal minimum of 8, we see a slowly increasing curve.

3.1 Using Block Memories—Step 38

When clustering is applied to create a generic power model, there must be a coefficient array for each type of component supported in the cluster. The size of each array increases to match the maximum bit width of the generic model (to avoid extra control logic). If implemented directly using lookup tables in LUTs on an FPGA, the coefficient arrays are a major contributor to the area overhead. Fortunately, FPGAs provide block memories, which are ideal for storing coefficients. It is, in fact, desirable to map the power models' coefficient ROMs to the FPGA's block memories. For example, Xilinx's CORE Generator tool offers the ability to configure a block memory macro with parameters such as width and depth. Since block RAM has at best a one-cycle latency, it is essential to read multiple coefficients per cycle. This is achieved by packing coefficients into long words and fetching the data appropriately for the power computations.

4.0 Sampling Rates

Steps 46 and 47 in FIG. 4 relate to component sampling. This section provides further details relative to those steps.

4.1 Determining Optimum Component Sampling Rates—Step 46

We derive the optimum sampling rates for each component based on the observation that components whose power consumptions have a higher mean and variance must be sampled more frequently. Let comp₁, comp₂ . . . compₙ denote n RTL components of a design. Assuming that we are sampling this set of components, the objective is to minimize the aggregate error due to sampling. If δPᵢ represents the estimated error due to sampling a component compᵢ, then the aggregate error for the entire design is given by

$$Δ P = {\sum }_{i = 1}^{n} δ {P}_{i}$$

Furthermore, during minimization, the errors associated with components with higher power should be considered more significant as compared to the errors associated with components with lower power. Therefore, we weigh the estimated error δPᵢ by the fractional power ƒᵢ given by the following:

$${f}_{i} = {P}_{compi} / {\sum }_{i = 1}^{n} {P}_{compi}$$

Therefore, the objective function being minimized can be written as

$$Minimize Δ P\_weighted = {\sum }_{i = 1}^{n} {f}_{i} * δ {P}_{i}$$

For normally distributed power profiles of an RTL component compᵢ, δPᵢ is governed by the following equation as described, for example, at R. Burchet al, “A Monte Carlo approach for power estimation,” IEEE Trans. VLSI Systems, Vol. 1, pp. 63-71, March 1993:
δ_{comp}_{ᵢ}≈t*s_{comp}_{ᵢ}/\sqrt{Nᵢ}

In the above equation, s_{comp}_{ᵢ} refers to the standard deviation of the power profile of compᵢ, Nᵢ is the number of samples for the component compᵢ and t is a positive constant. Therefore, the objective function can be re-written as

$$Minimize Δ P\_weighted = {\sum }_{i = 1}^{n} {f}_{i} * {s}_{compi} / \sqrt{{N}_{i}}$$

The constraints that must be obeyed during minimization can be formulated as follows. If we denote Nₜₒₜ to be the total number of simulation cycles,
N₁+ . . . +Nₙ≦Nₜₒₜ,
and
Nᵢ≧1, ∀i=1 . . . n

Since the above constraints are linear and the objective function is nonlinear, the minimization problem is a linearly constrained optimization problem. There are many well-known solvers such as MINOS. See, for example, “Using AMPL/MINOS (http://www.ampl.com/BOOKLETS/ampl-minos.pdf).” Such a solver can be used to determine the values of Nᵢ. Once N₁, . . . , Nₙ are determined, the sampling rate for each component Rᵢ can simply be written down as follows:
Rᵢ=Nᵢ/Nₜₒₜ

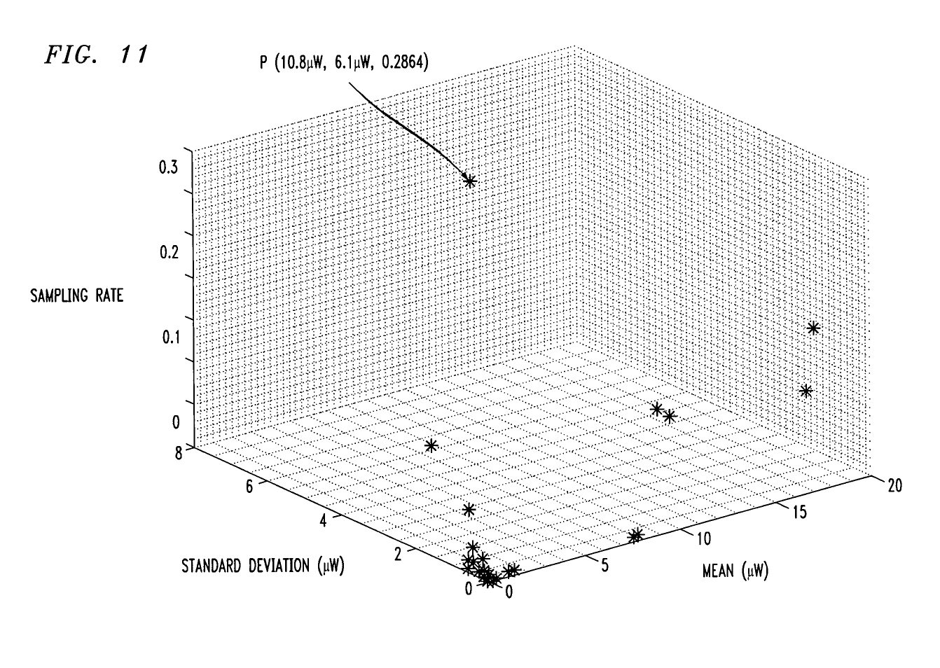

FIG. 11 shows the results of the above optimization procedure for the above-mentioned DES design. The design contains 1520 RTL components, and for each component, we plot the sampling rates computed based on the mean and standard deviation of the component's power consumption characteristics. For example, point P denotes the highest sampling rate of 0.2864 and corresponds to a component characterized by high mean power (10.8 μW) and high standard deviation (6.1 μW).

4.2 Minimizing Undersampling—Step 47

Let clusters CL₁, CL₂ . . . CLₘ denote a solution that is output by the above-mentioned hierarchical clustering algorithm. Assuming a uniform sampling rate for all the components in a given cluster, we can determine a measure of the estimation error introduced for a component compⱼ in cluster CLᵢ by computing the distance from its optimum sampling rate (denoted by the undersampling factor δRⱼᵢ):

$$\begin{matrix}δ {R}_{ji} = {R}_{j} - 1 / \vert {CL}_{i} \vert , if {R}_{j} > 1 / \vert {CL}_{i} \vert \\ = 0 , if {R}_{j} \leq 1 / \vert {CL}_{i} \vert\end{matrix}$$

where, (a) 1/|CLᵢ| denotes the uniform sampling rate for all components in a cluster CLᵢ with cardinality CLᵢ, (b) Rⱼ is the optimum sampling rate given in Section 4.1, and (c) the undersampling is zero if the optimum component sampling rates are met by the clustering solution, i.e., if Rⱼ≦1/|CLᵢ|. Therefore, the aggregate undersampling for the present clustering solution is given by

$$Δ R ( {CL}_{1} , {CL}_{2} … {CL}_{n} ) = {\sum }_{i = 1}^{n} {\sum }_{{comp}_{j} ∈ {CL}_{i}} δ {R}_{ji}$$

We minimize ΔR(CL₁, CL₂ . . . CLₙ) by using an iterative improvement algorithm based on the Kernighan-Lin heuristic to carefully select components that must be moved to other clusters to reduce undersampling, while ensuring that the target area constraint is not violated. See, for example, B. Kernighan and S. Lin, “An Efficient Heuristic Procedure for Partitioning Graphs,” The Bell System Tech J., Vol. 49, pp. 291-307, February 1970. The main steps of the algorithm are briefly outlined below:
1. For every component (compⱼ in CLᵢ), evaluate the gain of moving the component to every other cluster CLₖ from the perspective of undersampling:

$$\begin{matrix}Gain ( {comp}_{j} -> {CL}_{k} ) = Δ R ( {CL}_{1} … {CL}_{i} , {CL}_{k} … {CL}_{n} ) - \\ Δ R ( {CL}_{1} … {CL}_{i} - {comp}_{i} , {CL}_{k} + {comp}_{i} … {CL}_{n} )\end{matrix}$$
2. Evaluate the area in each case. If the target area constraint is not violated, choose the component-to-cluster move that results in the highest gain. Here, a move is chosen even if the highest gain is negative (results in increased undersampling) so as to enable better hill-climbing from local minima. Lock the component-to-cluster move for the rest of this pass.
3. Repeat Steps 1 and 2 until all modules are locked, and return the clustering solution with the lowest aggregate undersampling observed.
4. Terminate algorithm if the clustering solution returned is inferior to the starting solution in aggregate undersampling cost. Otherwise, repeat Steps 1, 2 and 3.
   5.0 Variations, Alternatives and Uses of Power Emulation

The results obtained from power emulation may be used to re-design the circuit using known design techniques, so that its power consumption is reduced. If the circuit contains a programmable processor, the result of power emulation may also be used to optimize the software running on the processor using known techniques, so that the circuit's power consumption is reduced.

Power emulation can be used to analyze the power consumption of a circuit during manufacturing test, under the application of a given set of test patterns. The results obtained from power emulation may thus be used to optimize the test patterns or the circuit itself so that the power consumption during manufacturing test is minimized.

The power estimation circuitry can be enhanced to process the power estimates computed by the power models in order to produce information useful to the designer. For example, the power estimation circuitry can be enhanced to automatically identify components with the highest power consumption, or components whose power consumption is above a specified threshold.

The power models for different parts of a circuit may operate at different levels of abstraction. For example, consider a circuit that contains a processor, memory, and bus, in addition to other circuitry. The power model for the processor could operate at the instruction level (i.e., compute the processor's power consumption by only observing the sequence of instructions it executes), while the power model for the memory may be based on the type of operations it performs (read, write, idle, etc), and the power model for the bus may be based on the types of transactions it executes.

Power emulation can be extended so that the circuitry added during emulation also computes the voltage drops seen on the supply and ground wires for each circuit component. The power estimation circuitry can also be extended to identify thermal hot-spots in the circuit. Another possible extension is to use additional circuitry during emulation to monitor the logical values at a subset of signals in the circuit and compute the electrical noise that would be generated at one or more signals (e.g., due to capacitive or inductive coupling).

The foregoing merely illustrates the principles of the invention. Those skilled in the art will be able to devise numerous arrangements, methods and techniques that, although not explicitly shown or described herein, embody those principles of the invention and thus are within their spirit and scope.

1. A method comprising
producing a circuit-implemented emulation that emulates a power-model-enhanced circuit, the power-model-enhanced circuit comprising a functional circuit and power estimation circuitry,
the power estimation circuitry being adapted to generate an estimate of the power consumption of functional circuitry of the functional circuit, the estimate being generated as a function of input signals applied to the circuit-implemented emulation when it is executed.

2. A circuit-implemented emulation of a power-model-enhanced circuit, the power-model-enhanced circuit comprising a functional circuit that is interconnected with power estimation circuitry, the power estimation circuitry being adapted to generate an estimate of the power consumption of functional circuitry of the functional circuit, the estimate being generated as a function of input signals applied to the circuit-implemented emulation when it is executed.

3. The method of claims 1 or 2 wherein the circuit-implemented emulation is a general purpose circuit that has been configured to emulate the power-model-enhanced circuit.

4. The method of claims 1 or 2 wherein the circuit-implemented emulation is an array of gates that have been interconnected in such a way as to emulate the power-model-enhanced circuit.

5. The method of claims 1 or 2 wherein the circuit-implemented emulation is a programmable gate array that is programmed in such a way as to emulate the power-model-enhanced circuit.

6. The method of claims 1 or 2 wherein the execution of the circuit-implemented emulation includes
applying a set of signals to a portion of the circuit-implemented emulation that emulates the functional circuitry, and
receiving an indication of said estimate from a portion of the circuit-implemented emulation that emulates the power estimation circuitry.

7. The method of claim 6 wherein the applied set of signals is generated using a test bench.

8. The method of claims 1 or 2 wherein the power estimation circuitry estimates the estimated power consumption as a function of a) said input signals and b) coefficients that characterize the power consumption characteristics of the functional circuitry.

9. The method of claim 8 wherein
the circuit-implemented emulation includes at least one block memory, and
at least ones of said coefficients are stored in said block memory.

10. The method of claim 8 wherein the functional circuitry includes at least first and second circuit components and wherein said power estimation circuitry includes first and second power model circuits associated with said first and second circuit components, respectively, the first and second power model circuits each being adapted to estimate the power consumption of the associated circuit component.

11. The method of claims 1 or 2 wherein the power estimation circuitry includes a least one power model circuit to which at least one of said input signals is applied, said power model circuit generating an estimate of the power consumption of at least a portion of the functional circuitry.

12. The method of claim 11 wherein
the functional circuitry includes two or more circuit components,
said at least one power model circuit estimates the power consumption of an individual one of the circuit components, and
said at least one power model circuit estimates the power consumption of the other circuit components as a function of the estimated power consumption of said individual one of said circuit components.

13. The method of claim 12 wherein the power consumption characteristics of each of said two or more circuit components meet a predetermined correlation criterion.

14. The method of claim 13 wherein the predetermined correlation criterion is that corresponding power consumption variables of said each of said two or more circuit components are linearly correlated to at least a predetermined extent.

15. The method of claim 11 wherein
the functional circuitry includes a cluster of two or more circuit components, and
said at least one power model circuit is adapted to estimate the power consumption of each of the circuit components of the cluster on a time-shared basis.

16. The method of claim 15 wherein said at least one power model circuit estimates the power consumption of at least one of the circuit components of the cluster at a lower rate than the rate of the input signals applied to that one of the circuit components.

17. The method of claims 1 or 2 wherein
the functional circuitry includes a plurality of clusters each formed of two or more circuit components, and
the power estimation circuitry includes power model circuits each associated with a respective one of the clusters, each power model circuit being adapted to estimate the power consumption of each of the circuit components of the associated cluster on a time-shared basis,
the clusters being formed in such a way that error in the power estimate made by the power estimation circuitry is less than if the clusters were to be formed in at least one other way.

18. The method of claim 17 wherein the clusters are formed in such a way that error in the power estimate made by the power estimation circuitry is less than if the clusters were to be formed in any other way.

19. The method of claim 17 wherein said at least one of the power model circuits estimates the power consumption of at least one of the circuit components of the associated cluster at a lower rate than the rate of the input signals applied to that one of the circuit components.

20. The method of claim 11 wherein said power model circuit estimates the power consumption of a combination of circuit components of the functional circuitry without explicitly taking account of at least one internal signal of that combination.

21. The method of claim 11 wherein said power model circuit includes at least one circuit resource having a function that is invoked two or more times successively during the power model circuit's generation of said power estimate.

22. The method of claim 21 wherein said circuit resource is an adder.

23. The method of claims 1 or 2 wherein
the functional circuitry comprises at least first and second circuit components, and
the power estimation circuitry estimates the power consumption of said first and second circuit components at different associated sampling rates.

24. The method of claim 23 wherein
at least a first measure of the power consumption of said first circuit component is higher than the corresponding measure of the power consumption of said second circuit component, and
the sampling rate associated with said first circuit component is higher than the sampling rate associated with said second circuit component.

25. A method comprising
generating a description of a power-model-enhanced circuit, the power-model-enhanced circuit comprising a functional circuit and power estimation circuitry that is adapted to generate a succession of estimates of the power consumption of a plurality of components of the functional circuit in response to signals that are input to those components,
producing a circuit-implemented emulation of the power-model-enhanced circuit by configuring a configurable circuit system in response to the description of the power-model-enhanced circuit,
executing the circuit-implemented emulation with a test bench, and
obtaining the power consumption estimates from the emulated power estimation circuitry.

26. The method of claim 25 wherein
the functional circuit includes a cluster of two or more circuit components, and
the power model estimation circuitry is adapted to estimate the power consumption of each of the circuit components of the cluster on a time-shared basis.

27. The method of claim 25 wherein the description of the power-model-enhanced circuit is in a predetermined circuit-description language.

28. The method of claim 25 wherein said executing the circuit-implemented emulation with a test bench comprises applying a set of signals to the circuit-implemented emulation and receiving the power consumption estimates from the circuit-implemented emulation.

29. The method of claim 25 wherein the power estimation circuitry comprises a plurality of power model circuits, each of the power model circuits being associated with at least one of the functional circuit components, and each of the power model circuits being adapted to receive the same inputs as respective associated ones of the functional circuit components and, in response to a strobe signal received at a particular time, to generate an estimate of the power consumption of at least one of the associated functional circuit components at that particular time.

30. The method of claim 29 wherein each of the functional circuit components is operated in response to at least one clock signal applied thereto and wherein said strobe signal received by a power model circuit is generated as a function of at least one of the clock signals applied to at least one functional circuit component associated with that power model circuit.

31. The method of claim 30 each power model circuit generates said estimate as a function of a) its received inputs and b) coefficients that characterize the power consumption characteristics of the associated functional circuit components.

32. The method of claim 31 wherein
the configurable circuit system includes at least one block memory, and
at least ones of said coefficients are stored in said block memory.

33. The method of claim 29 wherein at least one of the power model circuits is associated with two or more of the functional circuit components and estimates the power consumption of at least one of the associated functional circuit components as a function of the estimated power consumption of less than all of them.

34. The method of claim 29 wherein at least one of the power model circuits is associated with two or more of the functional circuit components and estimates the power consumption of at least one of the associated functional circuit components as a function of the estimated power consumption of one of them.

35. The method of claim 33 wherein the power consumption characteristics of each of said two or more functional circuit components meet a predetermined correlation criterion.

36. The method of claim 35 wherein the predetermined correlation criterion is that corresponding power consumption variables of said each of said two or more functional circuit components are linearly correlated to at least a predetermined extent.

37. The method of claim 30 wherein
at least one of the power model circuits is adapted to estimate the power consumption of each of two or more of the functional circuit components on a time-shared basis.

38. The method of claim 37 wherein said at least one of the power model circuits estimates the power consumption of at least one of the two or more functional circuit components at a lower rate than the rate of the input signals applied to that one of the circuit components.

39. The method of claim 25 wherein
the functional circuitry includes a plurality of clusters each formed of two or more of the functional circuit components, and
the power estimation circuitry includes power model circuits each associated with a respective one of the clusters, each power model circuit being adapted to estimate the power consumption of each of the functional circuit components of the associated cluster on a time-shared basis,
the clusters being formed in such a way that any error in the power estimate made by the power estimation circuitry is less than if the clusters were to be formed in at least one other way.

40. The method of claim 39 wherein said at least one of the power model circuits estimates the power consumption of at least one of the functional circuit components of the associated cluster at a lower rate than the rate of the input signals applied to that one of the circuit components.

41. The method of claim 30 wherein at least one of said power model circuits estimates the power consumption of a combination of functional circuit components without explicitly taking account of at least one internal signal of that combination.

42. The method of claim 30 wherein at least one of said power model circuits includes at least one circuit resource having a function that is invoked two or more times successively during the power model circuit's generation of an individual one of said power estimates.

43. The method of claim 42 wherein said circuit resource is an adder.

44. The method of claim 25 wherein
the power estimation circuitry estimates the power consumption of at least first and second functional circuit components at different associated sampling rates.

45. The method of claim 44 wherein
at least a first measure of the power consumption of said first functional circuit component is higher than the corresponding measure of the power consumption of said second functional circuit component, and
the sampling rate associated with said first functional circuit component is higher than the sampling rate associated with said second functional circuit component.
